(19) United States
(12) Patent Application Publication
(10) Pub. No.: US 2024/0385964 A1
(43) Pub. Date: Nov. 21, 2024

(54) METHOD, DEVICE AND STORAGE MEDIUM FOR REQUEST PROCESSING UNDER MIXED CACHELINE GRANULES

(71) Applicants: HEXIN Technologies (Suzhou) Co., Ltd., Suzhou (CN); Shanghai HEXIN Digital Technologies Co., Ltd., Shanghai (CN)

(72) Inventors: Yangfan LIU, Suzhou (CN); Shi SHI, Suzhou (CN); Pengfei GOU, Suzhou (CN); Yong LU, Suzhou (CN); Yue XU, Suzhou (CN)

(73) Assignees: HEXIN Technologies (Suzhou) Co., Ltd., Suzhou (CN); Shanghai HEXIN Digital Technologies Co., Ltd., Shanghai (CN)

(21) Appl. No.: 18/655,884

(22) Filed: May 6, 2024

(30) Foreign Application Priority Data
May 15, 2023 (CN) 202310541857.3

(51) Int. Cl. G06F 12/0811; G06F 12/0831; G06F 12/0891

(52) U.S. Cl. CPC G06F 12/0811; G06F 12/0831; G06F 12/0891

(57) ABSTRACT

The present application belongs to the field of chiplet technologies and discloses a method, device and storage medium for request processing under mixed cacheline granules. The method is applied to a processor, where a level 2 cache and a level 1 cache of the processor are integrated into a processor chiplet, and a level 3 cache of the processor is integrated into a fabric chiplet. The method includes: acquiring a level 1 cacheline granule of the level 1 cache and a level 3 cacheline granule of the level 3 cache; determining a cache working mode according to the level 1 cacheline granule and the level 3 cacheline granule; and receiving request information and processing the request information based on the cache working mode.

### CROSS-REFERENCE TO RELATED APPLICATIONS

This application claims priority to Chinese Patent Application No. 202310541857.3, filed on May 15, 2023, which is hereby incorporated by reference in its entirety.

### TECHNICAL FIELD

The present application relates to the field of chiplet technologies and, in particular, to a method, device and storage medium for request processing under mixed cacheline granules.

### BACKGROUND

Most modern processor have multiple levels of cache, with each level having a larger capacity and slower access time than the level below it. The levels are typically numbered, with level 1 (L1) being the smallest and fastest level of cache and level 3 (L3) being the largest and slowest level of cache.

Cacheline granules of multi-level cache systems in common processors are often the same, commonly 64 bytes (B) or 128 bytes. However, due to the slowing down of density improvement between semiconductor manufacturing nodes, the production of processors still faces problems of larger single chip area and lower yields.

The chiplet method is a solution to improve the overall yield of chip systems. The chiplet solution is to divide an original large chip into multiple small chips. For example, in a CPU chip, core, L1 and L2 are generally integrated into one chiplet, L3 and fabric are integrated into another chiplet, and an IO subsystem is integrated into yet another chiplet.

However, when the chiplets are interconnected, if a cacheline granule of a fabric chiplet is different from a cacheline granule of a processor chiplet, or if cacheline granules between internal caches of the processor chiplet are different, the two chiplets cannot be interconnected. The reason for this is that, from the perspective of cache operation, data modification of cache lines at the core level cannot correspond to a level 3 cache one by one, since a write operation of the level 1 cache may disrupt coherency in the level 3 cache, and from the perspective of link transmission, the expected data transmission sizes between the three levels of cache are also not coherent.

Therefore, there is a problem in the prior art that a processor chiplet and a fabric chiplet with different cacheline granules cannot be interconnected.

### SUMMARY

The present application provides a method, device and storage medium for request processing under mixed cacheline granules, which can ensure coherency of data transmission between different levels of cache, thereby realizing interconnection between a processor chiplet and a fabric chiplet when cacheline granules of internal caches of the processor chiplet are different or when cacheline granules of the processor chiplet and the fabric chiplet are different.

In a first aspect, an embodiment of the present application provides a method for request processing under mixed cacheline granules, applied to a processor, where a level 2 cache and a level 1 cache of the processor are integrated into a processor chiplet, and a level 3 cache of the processor is integrated into a fabric chiplet, and the method includes:
acquiring a level 1 cacheline granule of the level 1 cache and a level 3 cacheline granule of the level 3 cache;
determining a cache working mode according to the level 1 cacheline granule and the level 3 cacheline granule;
receiving request information and processing the request information based on the cache working mode.

Further, the cacheline granule of the level 2 cache is a first value; and
the request information includes a read request, a write request, a snoop request and a spinlock request.

The above embodiment illustrates that the present application can process various request information under the mixed cacheline granules of chiplets, which makes the present application applicable not only to single-core or multi-core processors, thereby indirectly improving applicability of the present application.

Further, the first value is 64 bytes. When the level 1 cacheline granule is 128 bytes and the level 3 cacheline granule is 64 bytes, the cache working mode is a first working mode; the processing the request information based on the cache working mode includes:
performing two hit detections in the level 2 cache according to the read request and sending 128-byte read data to a processor core in the processor chiplet according to the read request and two read hit results;
performing two hit detections in the level 2 cache according to the write request and updating 64-byte or 128-byte cache data in the level 2 cache according to the write request and two write hit results;
performing one hit detection in the level 2 cache according to the snoop request and sending a snoop response to a fabric according to a snoop hit result; recording a 128-byte address of the spinlock request according to the spinlock request.

The above embodiment enables the present application to realize the processing of request information under a cache configuration when the level 1 cacheline granule is 128 bytes and the level 3 cacheline granule is 64 bytes, and ensure coherency of data transmission between different levels of cache under the configuration of this cacheline granule, thereby enabling the processor chiplet and the fabric chiplet under the configuration of this cacheline granule to be interconnected.

Further, the first value is 64 bytes; when the level 1 cacheline granule is 128 bytes and the level 3 cacheline granule is 128 bytes, the cache working mode is a second working mode; the processing the request information based on the cache working mode includes:
performing two hit detections in the level 2 cache according to the read request and sending 128-byte read data to a processor core in the processor chiplet according to the read request and two read hit results;
performing two hit detections in the level 2 cache according to the write request and updating two 64-byte cache data in the level 2 cache according to the write request and two write hit results;
performing two hit detections in the level 2 cache according to the snoop request and sending a snoop response to a fabric according to two snoop hit results;
recording a 128-byte address of the spinlock request according to the spinlock request.

The above embodiment enables the present application to realize the processing of request information under a cache configuration when the level 1 cacheline granule and the level 3 cacheline granule are both 128 bytes, and ensure coherency of data transmission between different levels of cache under the configuration of this cacheline granule, thereby enabling the processor chiplet and the fabric chiplet under the configuration of this cacheline granule to be interconnected.

Further, the first value is 64 bytes; when the level 1 cacheline granule is 64 bytes and the level 3 cacheline granule is 64 bytes, the cache working mode is a third working mode; and the processing the request information based on the cache working mode includes:
performing one hit detection in the level 2 cache according to the read request and sending 64-byte read data to a processor core in the processor chiplet according to the read request and a read hit result;
performing one hit detection in the level 2 cache according to the write request and updating 64-byte cache data in the level 2 cache according to the write request and a write hit result;
performing one hit detection in the level 2 cache according to the snoop request and sending a snoop response to a fabric according to a snoop hit result; recording a 64-byte address of the spinlock request according to the spinlock request.

The above embodiment enables the present application to realize the processing of request information under a cache configuration when the level 1 cacheline granule and the level 3 cacheline granule are both 64 bytes, and ensure coherency of data transmission between different levels of cache under the configuration of this cacheline granule, thereby enabling the processor chiplet and the fabric chiplet under the configuration of this cacheline granule to be interconnected.

Further, the first value is 64 bytes; when the level 1 cacheline granule is 64 bytes and the level 3 cacheline granule is 128 bytes, the cache working mode is a fourth working mode; the processing the request information based on the cache working mode includes:
performing one hit detection in the level 2 cache according to the read request and sending 64-byte read data to a processor core in the processor chiplet according to the read request and a read hit result;
performing one hit detection in the level 2 cache according to the write request and updating 64-byte cache data in the level 2 cache according to the write request and a write hit result;
performing two hit detections in the level 2 cache according to the snoop request and sending a snoop response to a fabric according to two snoop hit results; recording a 128-byte address of the spinlock request according to the spinlock request.

The above embodiment enables the present application to realize the processing of request information under a cache configuration when the level 1 cacheline granule is 64 bytes and the level 3 cacheline granule is 128 bytes and ensure coherency of data transmission between different levels of cache under the configuration of this cacheline granule, thereby enabling the processor chiplet and the fabric chiplet under the configuration of this cacheline granule to be interconnected. Further, the processing the request information based on the cache working mode includes:
if the read request or the write request misses, acquiring missed request data through the fabric; and if the missed request data is 64 bytes, calculating the 64-byte request data in fabric data according to an address offset.

The above embodiment solves the problem that when the level 3 cacheline granule is 128 bytes and the missed data is 64 bytes, the size of the data transmitted to the level 2 cache is inconsistent with the size of the requested data, and the 64 bytes actually required is obtained from the 128 bytes that through the address offset, thereby ensuring correctness and coherency of data transmission in a multi-level cache.

Further, the processing the request information based on the cache working mode includes:
when the read request or the write request misses and replacement data is generated in the level 2 cache, marking the replacement data with byte enable before sending the replacement data to the level 3 cache.

In the above embodiment, the byte enable is used to mark which bytes are valid, thereby solving the problem that the replacement data is invalid after being transmitted to the level 3 cache when the size of the replacement data and the level 3 cacheline granule are different.

Further, the method further includes:
detecting whether the replacement data exists in the level 1 cache; if it exists, invalidating a cache line in the level 1 cache where the replacement data is located.

In the above embodiment, when the level 2 cache generates the replacement data, the existence of the replacement data in the level 1 cache is simultaneously detected, thereby ensuring consistency of data with the level 1 cache.

Further, the method further includes:
if the snoop request is an invalid request, detecting whether data corresponding to the invalid request exists in the level 1 cache;
if it exists, invalidating a cache line where the data corresponding to the invalid request is located in the level 1 cache.

In the above embodiment, data that may exist in the level 1 cache is synchronously invalidated when invaliding data, so as to ensure consistency of data with the level 1 cache; at the same time, considering that the level 1 cacheline granule may be different from the cacheline granule of the level 2 cache, the cache line where the data is located is directly requested to invalidate, so as to ensure that data in the level 1 cache can be definitely invalidated.

Further, the method further includes:
after recording the address of the spinlock request, if the level 2 cache receives the invalid request or generates replacement data, detecting whether an address of the data corresponding to the invalid request or an address of the replacement data is consistent with the address of the spinlock request;
if they are consistent, the spinlock request is invalidated and a lock grab fails.

In the above embodiment, by comparing the addresses of replacement data and invalid data in the level 2 cache with the recorded address of the spinlock, real-time monitoring of the spinlock request is realized, thereby avoiding a situation that the processor core keeps waiting, and realizing consistency of data between the level 2 cache and the processor core. That is, when the spinlock request fails, a failure of the lock grab will be notified immediately.

In a second aspect, an embodiment of the present application provides a computer device, including: a memory, a processor, and a computer program stored in the memory and running on the processor, where steps of the method for request processing under mixed cacheline granules according to any one of the above embodiments are executed when the processor executes the computer program.

In a third aspect, an embodiment of the present application provides a computer-readable storage medium, storing a computer program thereon, where steps of the method for request processing under mixed cacheline granules according to any one of the above embodiments are implemented when the computer program is executed by a processor.

To sum up, compared with the prior art, the beneficial effects given by the technical solutions provided by the embodiments of the present application at least include:
the present application provides a method for request processing under mixed cacheline granules. By setting various cache working modes, when a processor chiplet and a fabric chiplet are connected, a level 1 cacheline granule of a level 1 cache of the processor chiplet and a cacheline granule of a level 3 cache of the fabric chiplet are acquired, so that a current cache working mode is determined and received request information is processed based on the cache working mode, which can ensure coherency of data transmission between different levels of cache, thereby realizing interconnection between the processor chiplet and the fabric chiplet when cacheline granules of internal caches of the processor chiplet are different or when cacheline granules of the processor chiplet and the fabric chiplet are different.

### BRIEF DESCRIPTION OF DRAWINGS

FIG. 1 is a flowchart of a method for request processing under mixed cacheline granules provided by an embodiment of the present application.

FIG. 2 is a flowchart of processing of a read request under a first cache working mode and a second cache working mode provided by an embodiment of the present application.

FIG. 3 is a flowchart of processing of a read request under a third cache working mode and a fourth cache working mode provided by an embodiment of the present application.

FIG. 4 is a flowchart of processing of a write request under a first cache working mode and a second cache working mode provided by an embodiment of the present application.

FIG. 5 is a flowchart of processing of a write request under a third cache working mode and a fourth cache working mode provided by an embodiment of the present application.

FIG. 6 is a flowchart of processing steps of a snoop request provided by an embodiment of the present application.

FIG. 7 is a flowchart of processing steps of a spinlock request provided by an embodiment of the present application.

FIG. 8 is a schematic diagram of a read-write relationship between chiplets under four interconnection configurations with different cacheline granules provided by an embodiment of the present application.

### DESCRIPTION OF EMBODIMENTS

In the following, the technical solutions in the embodiments of the present application will be clearly and comprehensively described with reference to the drawings in the embodiments of the present application. Obviously, the described embodiments are merely a part of embodiments of the present application, not all of them. Based on the embodiments in the present application, all other embodiments obtained by those of ordinary skill in the art without creative effort belong to the protection scope of the present application.

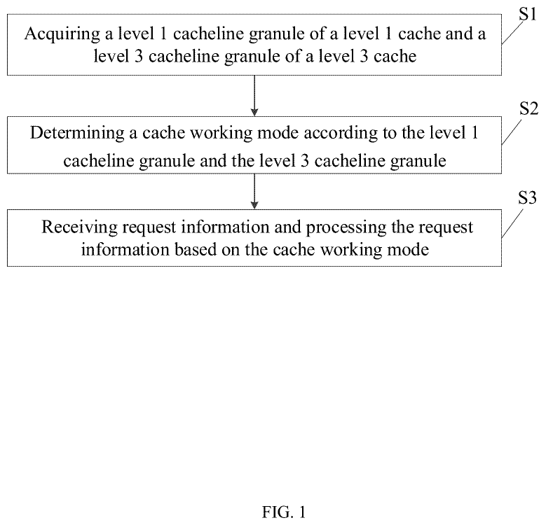

Referring to FIG. 1, an embodiment of the present application provides a method for request processing under mixed cacheline granules, applied to a processor, where a level 2 cache and a level 1 cache of the processor are integrated into a processor chiplet, a level 3 cache is integrated into a fabric chiplet, and the method includes the following steps.

Step S1, acquiring a level 1 cacheline granule of the level 1 cache and a level 3 cacheline granule of the level 3 cache.

Step S2, determining a cache working mode according to the level 1 cacheline granule and the level 3 cacheline granule.

Step S3, receiving request information and processing the request information based on the cache working mode.

The level 1 cache is L1 cache, the level 2 cache is L2 cache, and the level 3 cache is L3 cache. The core of the processor, L1 and L2 are integrated into the processor chiplet, and L3 and fabric are integrated into the fabric chiplet.

Specifically, after the handshake of L2 of the processor chiplet and L3 of the fabric chiplet, the cacheline granules of L1 and L3 are confirmed, and the cache working mode is determined according to the cacheline granules of L1 and L3.

Different cache working modes process the request information differently. After the handshake of the chiplets and determining the cache working mode, the processor processes the received request information based on the determined cache working mode.

The above embodiment provides the method for request processing under mixed cacheline granules. By setting various cache working modes, when a processor chiplet and a fabric chiplet are connected, a level 1 cacheline granule of a level 1 cache of the processor chiplet and a cacheline granule of a level 3 cache of the fabric chiplet are acquired, so that a current cache working mode is determined. Based on the cache working mode, received request information is processed, which can ensure coherency of data transmission between different levels of cache, thereby realizing interconnection between the processor chiplet and the fabric chiplet when cacheline granules of internal caches of the processor chiplet are different, or cacheline granules of the processor chiplet and the fabric chiplet are different.

In some embodiments, the cacheline granule of the level 2 cache is a first value.

The request information includes a read request, a write request, a snoop request and a spinlock request.

Specifically, the minimum of the level 1 cacheline granule and the level 3 cacheline granule is preferably for an L2 cache, that is, 64 B. At this time, the L1/L3 caches with sizes of 128 B/64 B can be connected. There are a total of four cacheline granule configurations. If the cacheline granule of L2 is 128 B, it will not be able to handle a situation that the cacheline granule configuration is L1=L3=64 B.

The above embodiment illustrates that the present application can process various request information under the mixed cacheline granules of chiplets, which makes the present application applicable not only to single-core or multi-core processors, thereby indirectly improving applicability of the present application.

In some embodiments, the first value is 64 bytes. When the level 1 cacheline granule is 128 bytes and the level 3 cacheline granule is 64 bytes, the cache working mode is a first working mode.

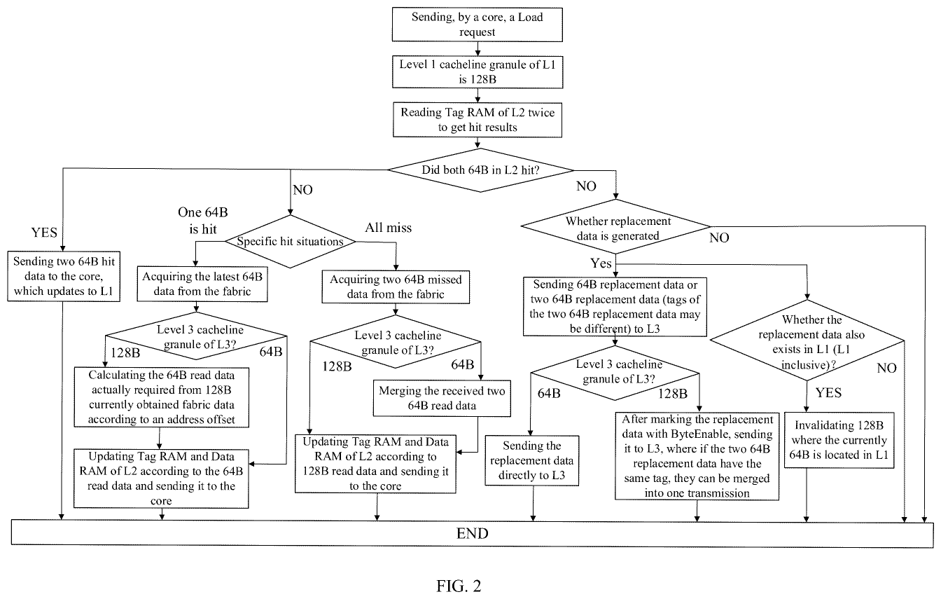

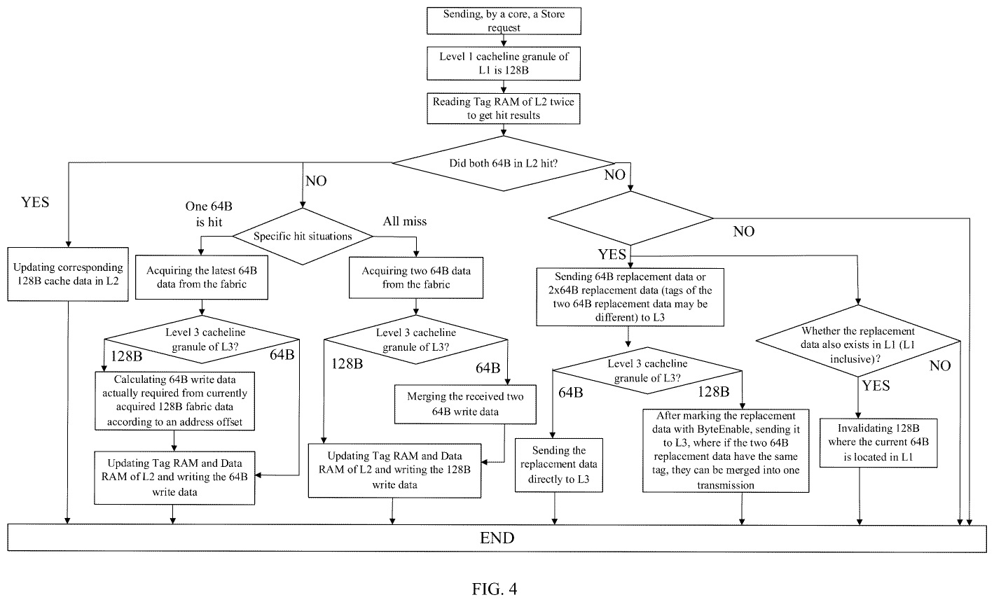

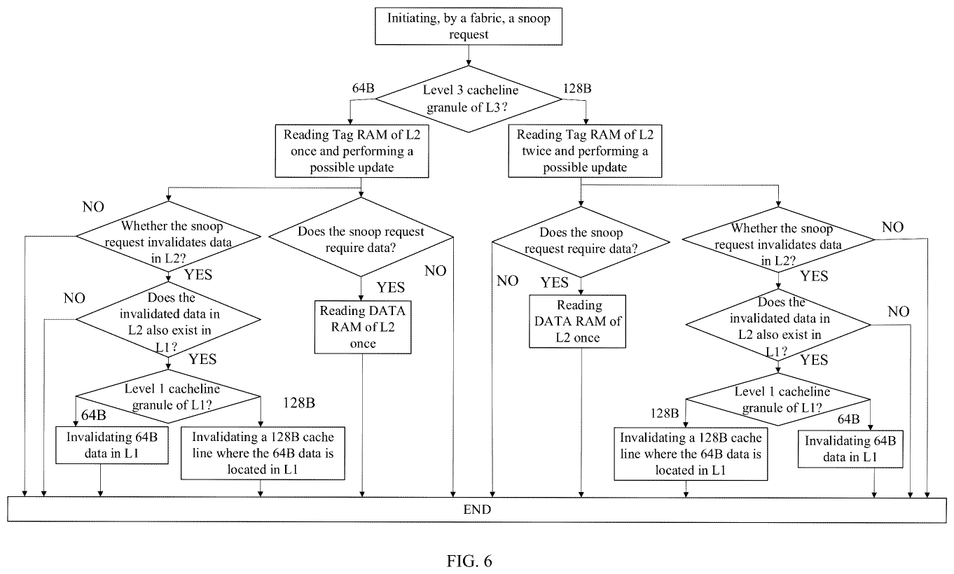

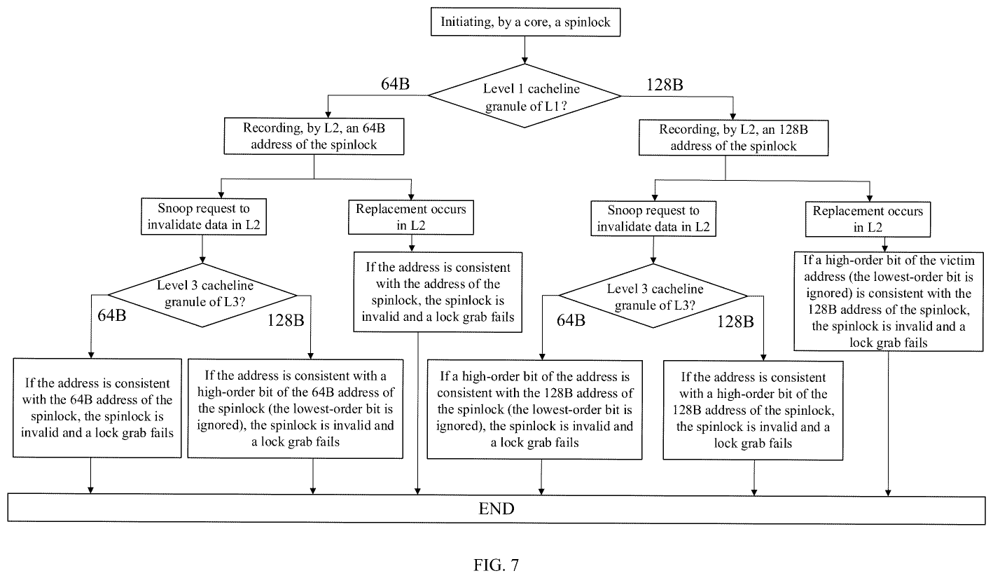

Referring to FIG. 2, FIG. 4, FIG. 6 and FIG. 7, the processing the request information based on the cache working mode includes the following steps.

Two hit detections are performed in the level 2 cache according to the read request and 128-byte read data are sent to the processor core in the processor chiplet according to the read request and two read hit results.

Two hit detections are performed in the level 2 cache according to the write request and 64-byte or 128-byte cache data in the level 2 cache are updated according to the write request and two write hit results.

Specifically, since L2=64 B and L1=128 B, the data that the 64 B L2 requests to be read from or written into is 128 B, it is necessary to detect whether two 64 B data in the 128 B requested data are all hit.

If all hits, two 64 B hit data are sent to the core, or the two 64 B cache data in L2 are updated.

If only one 64 B is hit, the other 64 B missed data is acquired from the fabric through L3; and after updating a Tag RAM and a Data RAM in L2, a total of 2×64 B hit and missed data are sent to the core, or the 64 B missed data are written into L2.

If all misses, two 64 B missed data are acquired from the fabric through L3; and after updating a Tag RAM and a Data RAM in L2, the two 64 B missed data are merged and sent to the core, or the two 64 B missed data are merged and written into L2.

One hit detection is performed in the level 2 cache according to the snoop request and a snoop response is sent to a fabric according to a snoop hit result; and a 128-byte address of the spinlock request is recorded according to the spinlock request.

Specifically, since L3-L2=64 B, the Tag RAM of L2 is accessed only once and a possible update is performed, where accessing the Tag RAM of L2 once means performing a hit detection, and whether to update is specifically determined by request content of the snoop request. If the snoop request hits and the snoop request needs to request data, the hit data is put into the snoop response together to be sent back to the fabric; and if the snoop request hits but does not request data or misses, the snoop response is sent directly.

The above embodiment enables the present application to realize the processing of request information under a cache configuration when the level 1 cacheline granule is 128 bytes and the level 3 cacheline granule is 64 bytes, and ensure coherency of data transmission between different levels of cache under the configuration of this cacheline granule, thereby enabling the processor chiplet and the fabric chiplet under the configuration of this cacheline granule to be interconnected.

In some embodiments, the first value is 64 bytes. When the level 1 cacheline granule is 128 bytes and the level 3 cacheline granule is 128 bytes, the cache working mode is a second working mode.

Referring to FIG. 2, FIG. 4, FIG. 6 and FIG. 7, the processing the request information based on the cache working mode includes the following steps.

Two hit detections are performed in the level 2 cache according to the read request and 128-byte read data are sent to the processor core in the processor chiplet according to the read request and two read hit results.

Two hit detections are performed in the level 2 cache according to the write request and two 64-byte cache data in the level 2 cache are updated according to the write request and two write hit results. Specifically, since L2=64 B and L1=128 B, the data that the L2 requests to be read from or written into is 128 B, it is necessary to detect whether all two 64 B data in the 128 B requested data are hit.

If all hits, two 64 B hit data are sent to the core, or the two 64 B cache data in L2 are updated.

If only one 64 B is hit, 128 B fabric data is acquired from the fabric through L3 and 64 B missed data included therein is acquired; and after updating a Tag RAM and a Data RAM in L2, a total of two 64 B hit and missed data are sent to the core, or the two 64 B fabric data are written into L2.

If all misses, 128 B missed data is acquired from the fabric through L3; and after updating the Tag RAM and the Data RAM in L2, the two 64 B missed data are sent to the core, or the two 64 B missed data are written into L2.

Two hit detections are performed in the level 2 cache according to the snoop request, and a snoop response is sent to the fabric according to two snoop hit results; and a 128-byte address of the spinlock request is recorded according to the spinlock request.

Specifically, since L3=128 B, it is necessary to access the Tag RAM of L2 twice and perform a possible update, where whether to update is specifically determined by request content of the snoop request. If the snoop request hits and needs to request data, the hit data is put into the snoop response together to be sent back to the fabric; and if both accesses miss, the snoop response will be sent directly.

The above embodiment enables the present application to realize the processing of request information under a cache configuration when the level 1 cacheline granule and the level 3 cacheline granule are both 128 bytes, and ensure coherency of data transmission between different levels of cache under the configuration of this cacheline granule, thereby enabling the processor chiplet and the fabric chiplet under the configuration of this cacheline granule to be interconnected.

In some embodiments, the first value is 64 bytes. When the level 1 cacheline granule is 64 bytes and the level 3 cacheline granule is 64 bytes, the cache working mode is a third working mode.

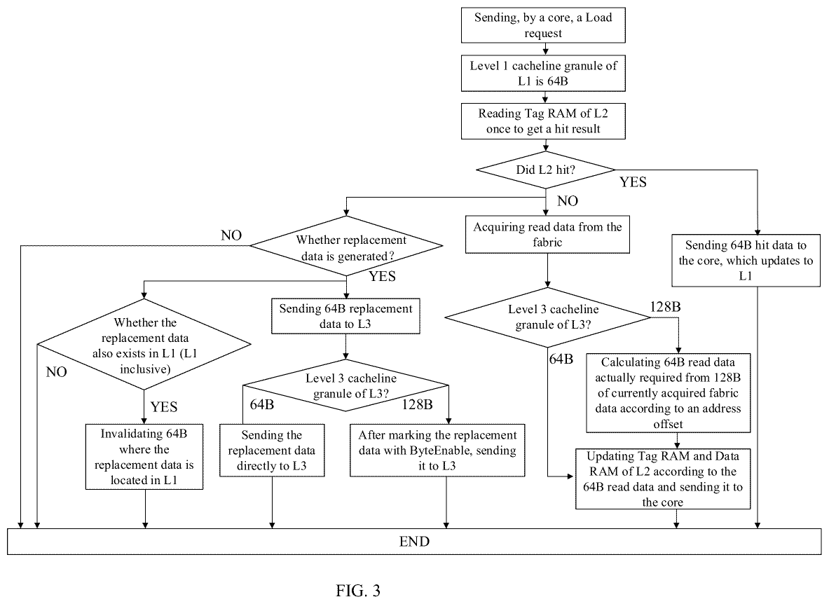

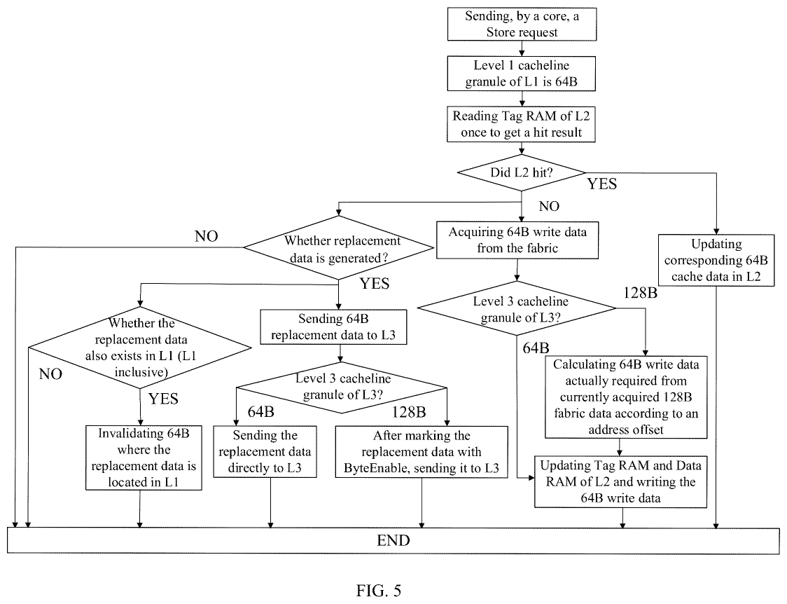

Referring to FIG. 3, FIG. 5, FIG. 6 and FIG. 7, the processing the request information based on the cache working mode includes the following steps.

One hit detection is performed in the level 2 cache according to the read request and 64-byte read data are sent to a processor core in the processor chiplet according to the read request and a read hit result.

One hit detection is performed in the level 2 cache according to the write request and 64-byte cache data in the level 2 cache are updated according to the write request and a write hit result. Specifically, since L1=L2=64 B, that is, data that the L2 requests to be read from or written into is 64 B, it is only necessary to read the Tag RAM of L2 once and perform one hit detection for the requested data.

If it hits, 64 B hit data is sent to the core, or the 64 B cache data in L2 is updated.

If it misses, 64 B missed data is acquired from the fabric through L3; and after updating the Tag RAM and the Data RAM in L2 according to the missed data, the 64 B missed data is sent to the core, or the 64 B missed data is written into L2.

One hit detection is performed in the level 2 cache according to the snoop request, and a snoop response is sent to a fabric according to a snoop hit result; and a 64-byte address of the spinlock request is recorded according to the spinlock request.

Specifically, since L3=L2=64 B, the Tag RAM of L2 is accessed only once and a possible update is performed, where whether to update is specifically determined by request content of the snoop request. If the snoop request hits and the snoop request needs to request data, the hit data is put into the snoop response together to be sent back to the fabric; and if the snoop request hits but does not request data or misses, the snoop response is sent directly.

The above embodiment enables the present application to realize the processing of request information under a cache configuration when the level 1 cacheline granule and the level 3 cacheline granule are both 64 bytes, and ensure coherency of data transmission between different levels of cache under the configuration of this cacheline granule, thereby enabling the processor chiplet and the fabric chiplet under the configuration of this cacheline granule to be interconnected.

In some embodiments, the first value is 64 bytes. When the level 1 cacheline granule is 64 bytes and the level 3 cacheline granule is 128 bytes, the cache working mode is a fourth working mode.

Referring to FIG. 3, FIG. 5, FIG. 6 and FIG. 7, the processing the request information based on the cache working mode includes the following steps.

One hit detection is performed in the level 2 cache according to the read request and 64-byte read data are sent to a processor core in the processor chiplet according to the read request and a read hit result.

One hit detection is performed in the level 2 cache according to the write request and 64-byte cache data in the level 2 cache is updated according to the write request and a write hit result. Specifically, since L1=L2=64 B, that is, data that the L2 requests to be read from or written into is 64 B, it is only necessary to read the Tag RAM of L2 once and perform one hit detection for the requested data.

If it hits, 64 B hit data is sent to the core, or the 64 B cache data in L2 is updated.

If it misses, 128 B fabric data is acquired from the fabric through L3 and 64 B missed data included therein is acquired; and after updating a Tag RAM and a Data RAM in L2, the 64 B missed data is sent to the core, or the 64 B missed data is written into L2.

Two hit detections are performed in the level 2 cache according to the snoop request, and a snoop response is sent to a fabric according to two snoop hit results; and a 128-byte address of the spinlock request is recorded according to the spinlock request.

Specifically, since L3=128 B, it is necessary to access the Tag RAM of L2 twice and perform a possible update, where whether to update is specifically determined by request content of the snoop request. If the snoop request hits and needs to request data, the hit data is put into the snoop response together to be sent back to the fabric; and if both accesses miss, the snoop response will be sent directly.

The above embodiment enables the present application to realize the processing of request information under a cache configuration when the level 1 cacheline granule is 64 bytes and the level 3 cacheline granule is 128 bytes, and ensure coherency of data transmission between different levels of cache under the configuration of this cacheline granule, thereby enabling the processor chiplet and the fabric chiplet under the configuration of this cacheline granule to be interconnected.

Referring to FIG. 2 to FIG. 5, in some embodiments, the processing the request information based on the working mode includes the following steps.

If the read request or the write request misses, missed request data is acquired through the fabric; and if the missed request data is 64 bytes, the 64-byte request data in fabric data is obtained by calculating according to an address offset.

Specifically, if L3=128 B, but 64 B data in L2 misses, the latest fabric data acquired through L3 is 128 B, and it is necessary to calculate the 64 B data actually required from 128 B fabric data according to the address offset, and send the 64 B data to the core or write it into L2.

The above embodiment solves the problem that when the level 3 cacheline granule is 128 B and the missed data is 64 B, the size of the data transmitted to the level 2 cache is inconsistent with the size of the requested data, and the 64 B actually acquired is obtained from the 128 B through the address offset, thereby ensuring correctness and coherency of data transmission in a multi-level cache.

Referring to FIG. 2 to FIG. 5, in some embodiments, the processing the request information based on the working mode includes:
when the read request or the write request misses and replacement data is generated in the level 2 cache, the replacement data is marked with byte enable before sending the replacement data to the level 3 cache.

Specifically, when L3=128 B, each piece of replacement data sent by L2 to L3 is 64 B in size, which is different from the cacheline granule of L3, thus the replacement data needs to be marked with Byte Enable.

If L2 needs to transmit two 64 B replacement data, and tags of the two pieces of replacement data are the same, the two pieces of replacement data can be merged into one transmission.

In the above embodiment, the byte enable is used to mark which bytes are valid, thereby solving the problem that the replacement data is invalid after being transmitted to the level 3 cache when the size of the replacement data and the level 3 cacheline granule are different.

Referring to FIG. 2 to FIG. 5, in some embodiments, the method further includes:
detecting whether the replacement data exists in the level 1 cache; if it exists, invalidating a cache line where the replacement data is located in the level 1 cache.

Specifically, when the replacement data is generated in L2, whether the replacement data exists in L1 is synchronously detected. If it exists in L1, a snoop request is sent to L1 to invalidate the replacement data existing in L1.

In the above embodiment, when the level 2 cache generates the replacement data, the existence of the replacement data in the level 1 cache is simultaneously detected, thereby ensuring consistency of data with the level 1 cache.

Referring to FIG. 6, in some embodiments, the method further includes:
if the snoop request is an invalid request, detecting whether data corresponding to the invalid request exists in the level 1 cache;
if it exists, invalidating a cache line where the data corresponding to the invalid request is located in the level 1 cache.

Specifically, if content of the snoop request received by L2 is to invalidate a part of data in L2, whether the invalidated data exists in L1 will be simultaneously detected. If it exists, the entire cache line where the data is located will be invalidated.

In a specific implementation process, L2=64 B and the 64 B data invalidated of L2 exists in L1. If L1=64 B, the 64 B in L1 where the data is located is directly invalidated. If L1=128 B, the entire 128 B cache line where the 64 B data is located is invalidated directly.

In the above embodiment, data that may exist in the level 1 cache is synchronously invalidated when invaliding data, so as to ensure consistency of data with the level 1 cache; at the same time, considering that the level 1 cacheline granule may be different from the cacheline granule of the level 2 cache, the cache line where the data is located is directly requested to invalidate, so as to ensure that data in the level 1 cache can be definitely invalidated.

Referring to FIG. 7, in some embodiments, the method further includes:
after recording the address of the spinlock request, if the level 2 cache receives the invalid request or generates replacement data, detecting whether an address of the data corresponding to the invalid request or an address of the replacement data is consistent with the address of the spinlock request; and
if they are consistent, the spinlock request is invalidated and a lock grab fails.

Specifically, after L2 records the address of the spinlock, if the stored address of the spinlock of L2 is invalidated by a snoop request from other caches, or the replacement data is generated due to a miss in processing the read request or the write request in L2 and the address of the spinlock is written as the replacement data, it will lead to the invalidation of the spinlock and the failure of the lock grab.

When the cacheline granule of L1 is 64 B, and the cacheline granule of L3 is 64 B, that is, the address of the spinlock request is 64 B, and the address of the data corresponding to the invalid request is also 64 B, it is directly judged whether the addresses of the two 64 B are consistent.

When the cacheline granule of L1 is 64 B, and the cacheline granule of L3 is 128 B, that is, the address of the invalid request data is 128 B, it is judged whether the address of the 128 B invalid request data is consistent with a high-order bit of the address (the lowest order bit is ignored) of the spinlock request. When L1=64 B, if replacement occurs in L2, it is judged whether the 64 B address of the replacement data is consistent with the address of the 64 B spinlock request.

When the cacheline granule of L1 is 128 B, and the cacheline granule of L3 is 128 B, that is, when the address of the spinlock request is 128 B, it is judged whether the high-order bit of the 128 B address of the spinlock request is consistent with the address of the invalid request data.

When the cacheline granule of L1 is 128 B, and the cacheline granule of L3 is 64 B, that is, the address of the invalid request data is 64 B, it is judged whether a high-order bit of the address of the invalid request data (the lowest order bit is ignored) is consistent with the 128 B address of spinlock request. When L1=128 B, if replacement occurs in L2, it is judged whether a high-order bit of the address of the replacement data is consistent with the 128 B address of the spinlock request.

If address consistency does not occur before the lock grab is successful, the core can successfully acquire resources protected by the spinlock.

In the above embodiment, by comparing the addresses of replacement data and invalid data in the level 2 cache with the recorded address of the spinlock, real-time monitoring of the spinlock request is realized, thereby avoiding a situation that the processor core keeps waiting, and realizing consistency of data between the level 2 cache and the processor core. That is, when the spinlock request fails, a failure of the lock grab will be notified immediately.

An example is given to illustrate the implementation process of the method for request processing under mixed cacheline granules of the present application:

The present application can realize interconnection between cache hierarchy with different cacheline granules, including cacheline granule scale down, same cacheline granule, and cacheline granule scale up. Since L2 and L1 are on a same chiplet, with the L2 cache (inclusive with L1, i.e., cache content of L1 is contained in L2) as a reference, the cacheline granule of L2 can be min (L1, L3)=64 B.

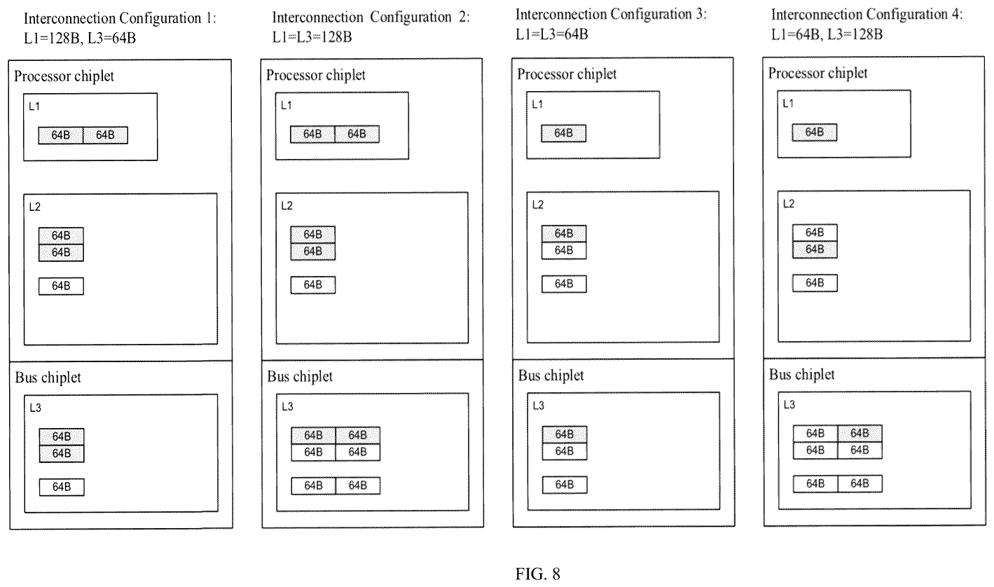

Referring to FIG. 8, Interconnect Configuration 1—cacheline scale down. The cacheline size of core L1 cache is 128 B and the cacheline size of fabric L3 cache is 64 B.

Interconnect Configuration 2—cacheline same 128 B. The cacheline sizes of the core L1 cache and the fabric L3 cache are both 128 B.

Interconnect Configuration 3—cacheline same 64 B. The cacheline sizes of the core L1 cache and the fabric L3 cache are both 64 B.

Interconnect Configuration 4—cacheline scale up. The cacheline size of core-L1 cache is 64 B and the cacheline size of fabric-L3 cache is 128 B.

In the present application, a cache refers to a storage unit (array) that actually stores data of an address, and dir refers to a storage unit (array) that stores a state of the cacheline and a high-order address (tag) of an address.

After a power-on reset, L2 on the CPU chiplet first handshakes with the Fabric chiplet to confirm each other's cacheline sizes. The cacheline size does not change during runtime.
Interconnection Configuration 1: when a store occurs in the core with a 128 B cacheline granule, the granule in L2 is 64 B, therefore the store operation will correspond to updating 64 B or 128 B data; when a load occurs in the core, L2 needs to correspond to the two 64 B data transmitted to the core, and at this time, if L2 misses, at most two snoop requests may be generated on the fabric; when a victim cast-out (cache replacement) occurs in L2, since the fabric cacheline granule is 64 B, at most two cast-outs (or only one cast-out, if a certain 64 B has been hit in L2) may be generated; and when the fabric initiates a snoop operation, such as snoop invalidate, one snoop request affects 64 B. When the core initiates a 128 B spinlock, an operation of the 64 B snoop in L2 will affect the 128 B spinlock.
Interconnection Configuration 2: when a store occurs in the core with a cacheline granule of 128 B, the granule in L2 is 64 B, therefore the store operation will correspond to updating two 64 B data; when a load occurs in the core, the two 64 B data will be updated correspondingly, and one request/snoop will be generated on the fabric at a time; when a victim cast-out occurs in L2, since the fabric cacheline granule is 128 B, additional marking byte enables is required during cast-out to mark which bytes are valid. The data is merged in the L3 cache, and the state is merged in the dir of L3. When the fabric initiates a snoop operation, one snoop affects 128 B. When the core initiates a 128 B spinlock, the 128 B spinlock in L2 will correspond to an address of the spinlock of the core one by one.
Interconnection Configuration 3: when a store occurs in the core with a cacheline granule of 64 B, the granule in L2 is 64 B, therefore the store operation will correspond to updating one 64 B data; when a load occurs in the core, the one 64 B data will be updated correspondingly, and one request/snoop will be generated on the fabric at a time; when a victim cast-out occurs in L2, since the fabric cacheline granule is a consistent 64 B, it can be written directly. When the fabric initiates a snoop operation, such as snoop invalidate, one snoop affects 64 B. When the core initiates a 64 B spinlock, the 64 B in L2 will correspond to the address of the spinlock of the core one by one.
Interconnection Configuration 4: when a store occurs in the core with a cacheline granule of 64 B, the granule in L2 is 64 B, therefore the store operation will correspond to updating one 64 B data; when a load occurs in the core, the one 64 B data will be updated correspondingly, and one request will be generated on the fabric at a time, but a critical hexword will be marked additionally, so that the fabric will transmit the required 64 B. When the fabric initiates a snoop operation, such as snoop invalidate, one snoop affects 128 B. When the core initiates a 64 B spinlock, the 128 B snoop in L2 will match the address of the spinlock according to the critical hexword (a 64 B offset address).

The present application can solve the interconnection problem between a processor chiplet and a fabric chiplet with different cacheline granules, and enable each chiplet to be reused for each other. For example, a CPU chiplet with a 64 B cacheline granule can be interconnected with a fabric chiplet with a 64 B cacheline granule or a 128 B cacheline granule; and the CPU chiplet with a 128 B cacheline granule can also be interconnected with the fabric chiplet with a 64 B cacheline granule or a 128 B cacheline granule. And there is no need to redesign CPU chiplet or fabric chiplet during interconnection. According to the size related to cacheline granule in the field of inter-chiplet transmission packet, the processor chiplet and the fabric chiplet can adapt themselves on their own.

An embodiment of the present application provides a computer device, which may include a processor, a memory, a network interface and a database connected through a system fabric. The processor of the computer device is configured to provide computing and control capabilities. The memory of the computer device includes a nonvolatile storage medium and an internal memory. The nonvolatile storage medium stores an operating system, a computer program and a database. The internal memory provides an environment for the operation of the operating system and the computer program in the nonvolatile storage medium. The network interface of the computer device is configured to communicate with an external terminal through a network connection. The computer program, when executed by the processor, enables the process to execute steps of the method for request processing under mixed cacheline granules according to any one of the above embodiments.

The working process, the working details and the technical effects of the computer device provided in the present embodiment can refer to the above embodiment of the method for request processing under mixed cacheline granules, and will not be repeated herein.

An embodiment of the present disclosure provides a computer-readable storage medium storing a computer program thereon, where when a processor executes the computer program, steps of the method for request processing under mixed cacheline granules in the above any embodiment are implemented. The computer-readable storage medium refers to a carrier for storing data, which may, but is not limited to, include a floppy disk, an optical disk, a hard disk, a flash memory, a USB flash drive and/or a memory stick, etc. The computer may be a general-purpose computer, a special-purpose computer, a computer network, or other programmable devices.

The working process, the working details and the technical effects of the computer-readable storage medium provided in the present embodiment can refer to the above embodiment of the method for request processing under mixed cacheline granules, and will not be repeated herein.

Those of ordinary skill in the art can understand that all or part of the processes for realizing the methods of the above embodiments can be completed by instructing related hardware through a computer program, which can be stored in a nonvolatile computer-readable storage medium, and when executed, may include the processes of the methods of the above embodiments. Any reference to a memory, storage, database or other medium used in the embodiments provided in the present application may include a non-volatile and/or volatile memory. The non-volatile memory may include a read-only memory (ROM), a programmable ROM (PROM), an electrically programmable ROM (EPROM), an electrically erasable programmable ROM (EEPROM), or a flash memory. The volatile memory may include a random access memory (RAM) or an external cache memory. By way of illustration and not limitation, the RAM is available in various forms, such as a static RAM (SRAM), a dynamic RAM (DRAM), a synchronous DRAM (SDRAM), a double data rate SDRAM (DDRSDRAM), an enhanced SDRAM (ESDRAM), a synchronous link (Synchlink) DRAM (SLDRAM), a memory bus (Rambus) direct RAM (RDRAM), a direct memory bus dynamic RAM (DRDRAM), and a memory bus dynamic RAM (RDRAM).

The technical features of the above embodiments can be combined in any way. In order to make the description concise, not all possible combinations of the technical features of the above embodiments are described. However, as long as there is no contradiction in the combinations of these technical features, they should be considered to be within the scope of the present specification.

The above embodiments only express several implementations of the present application, which are described in a more specific and detailed manner, but are not to be construed as a limitation of scope of the present application. It should be pointed out that for those of ordinary skill in the art, without departing from the conception of the present application, several deformations and improvements can be made, which all fall within the scope of protection of the present application. Therefore, the scope of protection of the present application shall be subject to the appended claims.

What is claimed is:

1. A method for request processing under mixed cacheline granules, wherein the method is applied to a processor, a level 2 cache and a level 1 cache of the processor are integrated into a processor chiplet, and a level 3 cache of the processor is integrated into a fabric chiplet; and the method comprises:
acquiring a level 1 cacheline granule of the level 1 cache and a level 3 cacheline granule of the level 3 cache;
determining a cache working mode according to the level 1 cacheline granule and the level 3 cacheline granule;
receiving request information and processing the request information based on the cache working mode.

2. The method according to claim 1, wherein a cacheline granule of the level 2 cache is a first value;
the request information comprises a read request, a write request, a snoop request and a spinlock request.

3. The method according to claim 2, wherein the first value is 64 bytes; when the level 1 cacheline granule is 128 bytes and the level 3 cacheline granule is 64 bytes, the cache working mode is a first working mode;
the processing the request information based on the cache working mode comprises:
performing two hit detections in the level 2 cache according to the read request and sending 128-byte read data to a processor core in the processor chiplet according to the read request and two read hit results;
performing two hit detections in the level 2 cache according to the write request and updating 64-byte or 128-byte cache data in the level 2 cache according to the write request and two write hit results;
performing one hit detection in the level 2 cache according to the snoop request and sending a snoop response to a fabric according to a snoop hit result; recording a 128-byte address of the spinlock request according to the spinlock request.

4. The method according to claim 2, wherein the first value is 64 bytes; when the level 1 cacheline granule is 128 bytes and the level 3 cacheline granule is 128 bytes, the cache working mode is a second working mode;
the processing the request information based on the cache working mode comprises:
performing two hit detections in the level 2 cache according to the read request and sending 128-byte read data to a processor core in the processor chiplet according to the read request and two read hit results;
performing two hit detections in the level 2 cache according to the write request and updating two 64-byte cache data in the level 2 cache according to the write request and two write hit results;
performing two hit detections in the level 2 cache according to the snoop request and sending a snoop response to a fabric according to two snoop hit results; recording a 128-byte address of the spinlock request according to the spinlock request.

5. The method according to claim 2, wherein the first value is 64 bytes; when the level 1 cacheline granule is 64 bytes and the level 3 cacheline granule is 64 bytes, the cache working mode is a third working mode;
the processing the request information based on the cache working mode comprises:
performing one hit detection in the level 2 cache according to the read request and sending 64-byte read data to a processor core in the processor chiplet according to the read request and a read hit result;
performing one hit detection in the level 2 cache according to the write request and updating 64-byte cache data in the level 2 cache according to the write request and a write hit result;
performing one hit detection in the level 2 cache according to the snoop request and sending a snoop response to a fabric according to a snoop hit result; recording a 64-byte address of the spinlock request according to the spinlock request.

6. The method according to claim 2, wherein the first value is 64 bytes; when the level 1 cacheline granule is 64 bytes and the level 3 cacheline granule is 128 bytes, the cache working mode is a fourth working mode;
the processing the request information based on the cache working mode comprises:
performing one hit detection in the level 2 cache according to the read request and sending 64-byte read data to a processor core in the processor chiplet according to the read request and a read hit result;
performing one hit detection in the level 2 cache according to the write request and updating 64-byte cache data in the level 2 cache according to the write request and a write hit result;
performing two hit detections in the level 2 cache according to the snoop request and sending a snoop response to a fabric according to two snoop hit results; recording a 128-byte address of the spinlock request according to the spinlock request.

7. The method according to claim 4, wherein the processing the request information based on the cache working mode comprises:
upon determining that the read request or the write request misses, acquiring missed request data through the fabric; upon determining that the missed request data is 64 bytes, calculating the 64-byte request data in fabric data according to an address offset.

8. The method according to claim 6, wherein the processing the request information based on the cache working mode comprises:
upon determining that the read request or the write request misses, acquiring missed request data through the fabric; upon determining that the missed request data is 64 bytes, calculating the 64-byte request data in fabric data according to an address offset.

9. The method according to claim 4, wherein the processing the request information based on the cache working mode comprises:
when the read request or the write request misses and replacement data is generated in the level 2 cache, marking the replacement data with byte enable before sending the replacement data to the level 3 cache.

10. The method according to claim 6, wherein the processing the request information based on the cache working mode comprises:
when the read request or the write request misses and replacement data is generated in the level 2 cache, marking the replacement data with byte enable before sending the replacement data to the level 3 cache.

11. The method according to claim 9, wherein marking the replacement data with byte enable before sending the replacement data to the level 3 cache comprises:
upon determining that the replacement data are two 64 bytes and high-order addresses of the two 64-byte replacement data are the same, merging the two 64-byte replacement data.

12. The method according to claim 9, wherein the method further comprises:
detecting whether the replacement data exists in the level 1 cache;
upon determining that the replacement data exists, invalidating a cache line where the replacement data is located in the level 1 cache.

13. The method according to claim 3, wherein the processing the request information based on the cache working mode comprises:
upon determining that the read request or the write request misses, acquiring missed request data through the fabric; upon determining that the missed request data are two 64 bytes, merging the two 64-byte request data.

14. The method according to claim 3, wherein the processing the request information based on the cache working mode comprises:
when the read request or the write request misses and replacement data is generated in the level 2 cache, sending the replacement data directly to the level 3 cache.

15. The method according to claim 3, wherein the method further comprises:
upon determining that the snoop request is an invalid request, detecting whether data corresponding to the invalid request exists in the level 1 cache;
upon determining that the data corresponding to the invalid request exists, invalidating a cache line where the data corresponding to the invalid request is located in the level 1 cache.

16. The method according to claim 6, wherein the method further comprises:
upon determining that the snoop request is an invalid request, detecting whether data corresponding to the invalid request exists in the level 1 cache;
upon determining that the data corresponding to the invalid request exists, invalidating a cache line where the data corresponding to the invalid request is located in the level 1 cache.

17. The method according to claim 15, wherein the method further comprises:
after recording the address of the spinlock request, upon determining that the level 2 cache receives the invalid request or generates replacement data, detecting whether an address of the data corresponding to the invalid request or an address of the replacement data is consistent with the address of the spinlock request; upon determining the address of the data corresponding to the invalid request or the address of the replacement data is consistent with the address of the spinlock request, the spinlock request is invalidated and a lock grab fails.

18. The method according to claim 17, wherein upon determining that the level 2 cache receives the invalid request or generates replacement data, detecting whether an address of the data corresponding to the invalid request or an address of the replacement data is consistent with the address of the spinlock request comprises:
detecting whether a high-order bit of the address of the invalid request data is consistent with the address of the spinlock request, wherein a lowest-order bit of the address of the invalid request data is ignored; or
detecting whether a high-order bit of the address of the replacement data is consistent with the address of the spinlock request.

19. A computer device, comprising: a memory, a processor, and a computer program stored in the memory and executable on the processor, wherein a level 2 cache and a level 1 cache of the processor are located in a processor chiplet, and a level 3 cache of the processor is located in a fabric chiplet, and when the computer program is executed by the processor, the processor is configured to:
acquire a level 1 cacheline granule of a level 1 cache and a level 3 cacheline granule of a level 3 cache;
determine a cache working mode according to the level 1 cacheline granule and the level 3 cacheline granule;
receive request information and process the request information based on the cache working mode.

20. A non-transitory computer-readable storage medium, having a computer program stored thereon, wherein a level 2 cache and a level 1 cache of a processor are located in a processor chiplet, and a level 3 cache of the processor is located in a fabric chiplet, and when the computer program is executed by the processor, the processor is configured to:
acquire a level 1 cacheline granule of a level 1 cache and a level 3 cacheline granule of a level 3 cache;
determine a cache working mode according to the level 1 cacheline granule and the level 3 cacheline granule;
receive request information and process the request information based on the cache working mode.
